(19) United States
(12) Patent Application Publication
(10) Pub. No.: US 2013/0068067 A1
(43) Pub. Date: Mar. 21, 2013

(54) REAR-COVER FOR A TRANSMISSION AND METHOD FOR COATING THEREOF

(71) Applicant: Chang Yeol Yoo, Incheon (KR)

(72) Inventor: Chang Yeol Yoo, Incheon (KR)

(73) Assignee: HYUNDAI MOTOR COMPANY, Seoul (KR)

(21) Appl. No.: 13/323,388

(22) Filed: Dec. 12, 2011

(30) Foreign Application Priority Data
Sep. 20, 2011 (KR) 10-2011-0094373

(51) Int. Cl. F16H 57/029

(52) U.S. Cl. 74/606 R

(57) ABSTRACT

Disclosed is a rear-cover for a transmission made of an aluminum alloy which includes a sealing contact part in contact with a sealing of a retainer that is partially subjected to an anodizing coating process to form an aluminum oxide film thereon and is directly in contact with the sealing of the retainer, and a method for preparing the transmission rear-cover.

### CROSS-REFERENCE TO RELATED APPLICATION

This application claims under 35 U.S.C. §119(a) the benefit of Korean Patent Application No. 10-2011-0094373 filed on Sep. 20, 2011, the entire contents of which are incorporated herein by reference.

### BACKGROUND

(a) Technical Field

The present invention relates to a rear cover for a transmission of which a sealing contact part is subjected to a high abrasion-resistant coating, without hot press-fitting an insert sleeve made of steel into the transmission rear-cover, and a method for coating the transmission rear-cover.

(b) Background Art

In general, a transmission includes: a gear train having a combination of a planetary gear sets, a plurality of clutches, and brakes which are disposed on an input shaft connected to a torque converter; a transfer shaft which is disposed on one side of the input shaft; and transfer gears which are disposed on the transfer shaft, receive a driving force transferred from one operating element of the planetary gear set, and perform deceleration. Additionally, a differential on which drive shafts are mounted is disposed on one side of the input shaft and the transfer shaft as well.

Such a transmission often supplies, as shown in FIG. 1, oil pressure through a rear-cover 1, in which a plurality of sealings 5 made of resin are interjacent between the rear-cover 1 and a retainer 3 to retain airtightness. Also, in order to overcome an abrasion from the sealings 5, a sleeve 7 made of steel is hot press-fitted between the rear-cover 1 and the retainer 3 thereof.

However, the use of the sleeve 7 which is hot press-fitted into the rear-cover 1 may cause the sleeve 7 to be turned/rotated or shifted by the rotation thereof. When this happens, a flow channel (L) formed within the sleeve 7 becomes disconnected with a flow channel (G) formed on the rear-cover 1 thus blocking the oil passage therethrough, thereby resulting in shift failure or shock.

Specifically, in the conventional method described above, the recover is manufactured by a die casting rear-cover, and heating the manufactured rear cover to 150° C. Then a sleeve is hot press-fitted at 600 kgf thereto is to prevent the occurrence of extreme abrasion due to the contact of a seal portion with a portion of the sleeve in the preparation of the rear-cover using fine treatment material. Although such a hot press-fitting process may overcome the abrasion problem and reduce costs, it leads to a high defect rate in the procedure of heating the sleeve and hot press-fitting the steel sleeve.

The above information disclosed in this Background section is only for enhancement of understanding of the background of the invention and therefore it may contain information that does not form the prior art that is already known to a person of ordinary skill in the art.

### SUMMARY OF THE DISCLOSURE

The present invention has been made in an effort to solve the above-described problems associated with the conventional art, and it is an object of the present invention to provide a rear-cover for a transmission in which a sealing contact part is subjected to a high abrasion-resistant coating, instead of the hot press-fitting of an insert sleeve made of steel into the rear-cover, and a method for coating the transmission rear-cover.

In one aspect, the present invention provides a transmission rear-cover made of an aluminum alloy, in which a sealing contact part in contact with a sealing of a retainer is partially subjected to an anodizing coating process to form an aluminum oxide film thereon and is directly in contact with the sealing of the retainer.

The aluminum oxide film may have a thickness of 5 to 10 μm. The transmission rear-cover may be partially exposed in the sealing contact part thereof and the sealing contact part may be immersed in an electrolyte comprising Na₂SiO₃-9H₂O, KF-2H₂O and an aqueous KOH solution for a coating process to form an aluminum oxide film thereon.

In another aspect, the present invention provides a method for preparing the transmission rear-cover according to an exemplary embodiment of the present invention, which comprises immersing the sealing contact part of the rear-cover in an electrolyte bath, and coating the sealing contact part by addition of Na₂SiO₃-9H₂O, KF-2H₂O and an aqueous KOH solution in the electrolyte bath and applying a voltage thereto.

Also, the method of the present invention may further comprise mounting a jig on the lower end of the transmission rear-cover so as to expose only the sealing contact part of the rear-cover. Coating the sealing contact part may be carried out in 10 to 15 g/l of Na₂SiO₃-9H₂O, 3 to 5 g/l of KF-2H₂O and 2 to 4 g/l of an aqueous KOH solution at a temperature of 30 to 50° C. by applying a voltage of 50 to 70 V so as to coat the sealing contact part.

Immersing may further include degreasing the sealing contact part by applying an electrical current in 30 g/l of an aqueous Na₃PO₄ solution, etching the sealing contact part in 180 g/l of an aqueous CrO₃ solution at a temperature of 20 to 30° C.; and activating the sealing contact part in 2 to 4 g/l of an aqueous KOH solution at a temperature of 20 to 30° C. Coating the sealing contact part may further include sealing the sealing contact part in an aqueous ethylene solution at a temperature of 20 to 30° C.; and drying the sealing contact part at a temperature of 80 to 100° C.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view showing a transmission rear-cover equipped with a sleeve according to the conventional art;

FIG. 2 is a perspective view showing a rear-cover for a transmission according to one example of the present invention;

FIG. 3 is a view schematically showing an apparatus for coating the rear-cover of the transmission illustrated in FIG. 2; and

FIG. 4 is a view showing a method for testing the rear-cover of the transmission illustrated in FIG. 2.

FIG. 5 is a cross-sectional view showing a rear-cover for a transmission illustrated in FIG. 2.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The transmission rear-cover according to the present invention and the method for coating thereof will hereinafter be in detail described with regard to the preferred embodiments with reference to the accompanying drawings.

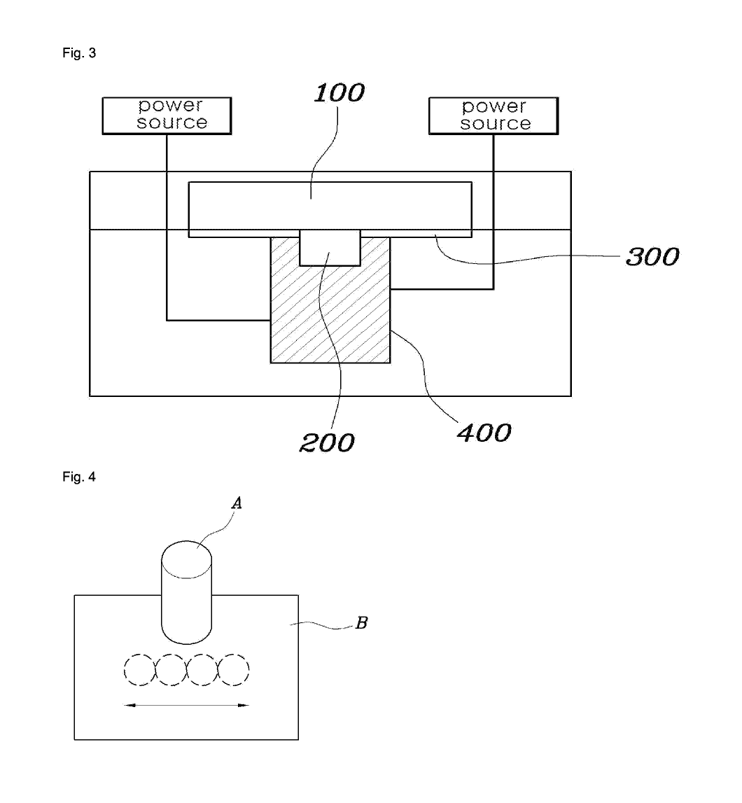

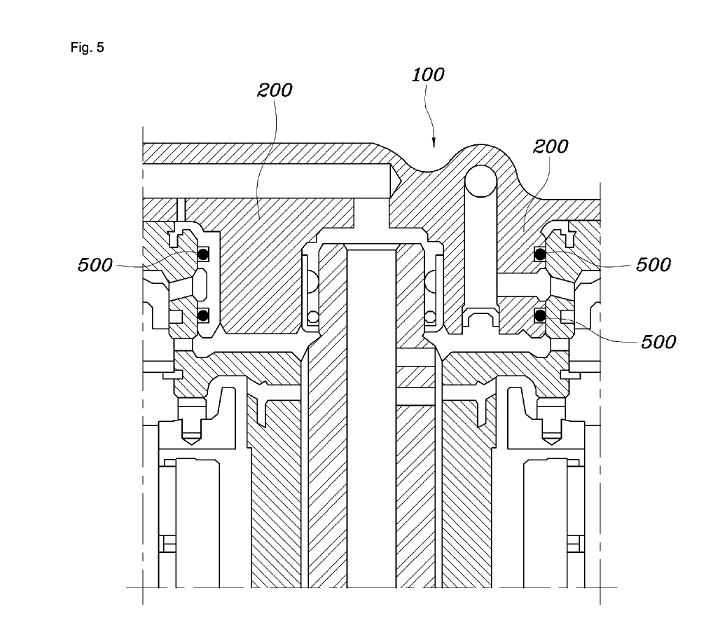

FIG. 2 is a perspective view showing a rear-cover for a transmission according to one example of the present invention, and FIG. 3 is a view schematically showing an apparatus for coating the rear-cover of the transmission illustrated in FIG. 2. The rear-cover for the transmission of the exemplary embodiment of the present invention is made of an aluminum alloy, which is characterized in that its sealing contact part 200 in contact with a sealing of a retainer 500 is partially subjected to an anodizing coating process to form an aluminum oxide film thereon, and is directly in contact with the sealing of the retainer 500.

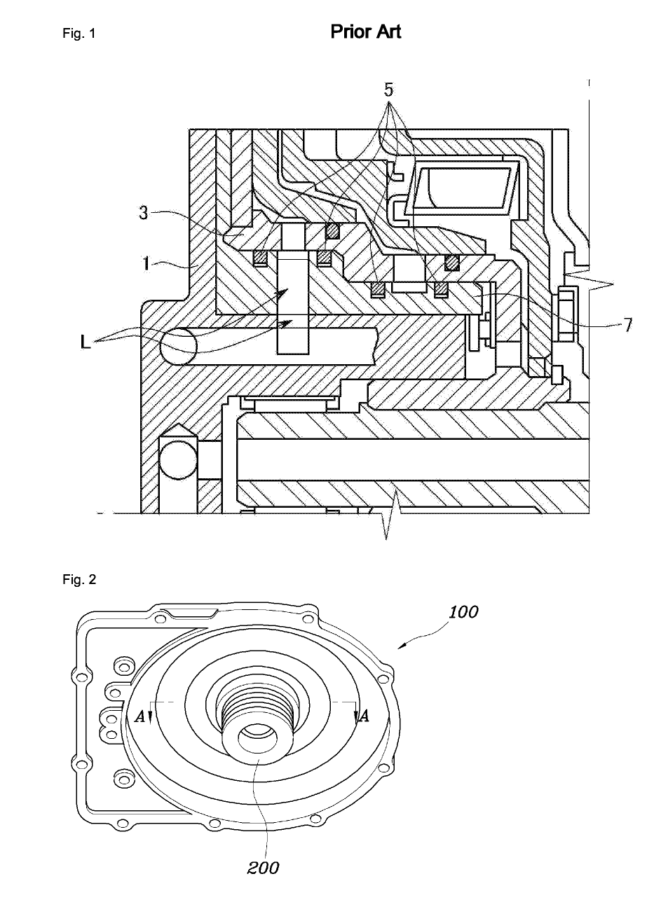

Also, the aluminum oxide film may have a thickness of 5 to 10 μm, and the sealing contact part of the transmission rear-cover may be partially exposed and immersed in an electrolyte composed of Na₂SiO₃-9H₂O, KF-2H₂O and an aqueous KOH solution for a coating process to form an aluminum oxide film on the sealing contact part 200. Specifically, the rear-cover of the transmission of the illustrative embodiment of the present invention has a sealing contact part 200 coated with an aluminum oxide film by an anodizing coating process, instead of the sealing contact part equipped with a sleeve (See FIG. 1).

Thus, the illustrative embodiment of the present invention reduces the weight of a product since a sleeve is not used in the manufacture thereof. Additionally, the illustrative embodiment of the present invention also improves abrasion resistance and solves of the oil circulation problems associated with the convention sleeve system.

A method for preparing the transmission rear-cover according to the present invention initiates by immersing the sealing contact part 200 of the rear-cover of the transmission 100 in an electrolyte bath 400, and coating the sealing contact part 200 by addition of Na₂SiO₃-9H₂O, KF-2H₂O and an aqueous KOH solution to the electrolyte bath 400 and applying a voltage thereto.

Also, the method of the present invention may further include mounting a jig 300 on the lower end of the rear-cover of the transmission 100 to expose only the sealing contact part 200 of the rear-cover. Preferably, coating is characterized by 10 to 15 g/l of Na₂SiO₃-9H₂O, 3 to 5 g/l of KF-2H₂O and 2 to 4 g/l of an aqueous KOH solution at a temperature of 30 to 50° C. and applying a voltage of 50 to 70 V to coat the sealing contact part 200 thereby.

In the illustrative embodiment of the present invention, the jig may be prepared in a size (e.g., 200×300 mm) adapted to be fit on the rear-cover and then mounted thereon. The jig is preferably made of a polymer material so as to block an electrical current. The sealing contact part in this example is exposed (R=50 mm) for surface treatment as shown in FIG. 3. The surface treatment forms anodic oxide films (i.e., an anodizing process). The surface treatment by anodic oxidation (anodizing) deposits layers of fine Al₂O₃ on the surface of products. In the anodizing process, portions with are intended to be coated are subject to contact with an electrolyte.

Only the sealing contact part 200 of the rear-cover which is coated, in this case, is exposed by a jig and immersed in a bath. Preferably, each of five baths prepared in a size of 150×200 mm is filled with a solution as shown in FIG. 3 and is subjected to degreasing, etching, activation, coating, sealing and drying, respectively. Degreasing and etching are to remove impurities on the surface of products, and activating neutralizes an acidified surface to facilitate coating.

As stated above, it is preferred that the method for preparing the rear-cover of the transmission according to the exemplary embodiment of the present invention include procedures for degreasing—etching—activating—coating—sealing—drying. That is, immersing may further include degreasing the sealing contact part 200 by applying an electrical current to 30 g/l of an aqueous Na₃PO₄ solution, etching the sealing contact part 200 in 180 g/l of an aqueous CrO₃ solution at a temperature of 20 to 30° C.; and activating the sealing contact part 200 in 2 to 4 g/l of an aqueous KOH solution at a temperature of 20 to 30° C.

Also, coating the sealing contact part 200 may further include sealing the sealing contact part 200 in an aqueous ethylene solution at a temperature of 20 to 30° C.; and drying the sealing contact part 200 at a temperature of 80 to 100° C.

Further, sealing is provided to fill the porosities of the anodized surface and drying is designed to facilitate the impregnation of the sealing solution into the porosities. By using such a procedure, an anodic oxide film of Al₂O₃ having a thickness of 20 to 30 μm is formed on the sealing contact part 200, which is obtained by the following reaction mechanism of water and aluminum, and the Na₂SiO₃-9H₂O, KF-2H₂O and KOH in the coating solution function to facilitate the ionization of water:

2H₂O→20H⁻+H₂

2Al+30H⁻→Al₂O₃+3H₂

The anodic oxide film formed thereby is in contact with the sealing of a retainer 500, thereby preventing the sealing contact part of the rear-cover from abrasion. The anodic oxide film formed may be evaluated for abrasion resistance by carrying out an abrasion test as shown in FIG. 4. For the abrasion test, the sealing (A) of a retainer which is a rod-type is subject to surface contact with the sealing contact part (B) of a rear-cover which is a plate-type sample in a direction perpendicular to the axis of the sealing contact part under the specific conditions shown in Table 1.

TABLE 1

| Frequency | 10 | Hz |
|---|---|---|
| Stroke | 10.6 | mm |
| Load | 40N | |
| Time | 20 | minutes |
| Oil | 6-speed ATF | |
| Oil Temperature | 85° | C. |

| | |
|---|---|
| Abrasion Direction | Perpendicular direction to the axis of the |
| | sealing contact part |

In the abrasion test, while the sample manufactured with a steel sleeve has an abrasion depth of 10 μm, the anodizing samples improved by the present invention have an abrasion depth of 3 μm) at a sample thickness of 3 to 5 μm) and an abrasion depth of 2 μm at a sample thickness of 10 to 15 μm. Thus, the improved anodizing samples having a thickness of 10 to 15 μm exhibit outstandingly improved abrasion resistance (about 5 times improvement) as compared with the steel sleeve.

Advantageously, the present invention provides a rear-cover for a transmission of a vehicle and the method for coating thereof as mentioned above. In particular, an abrasion-resistant coating is applied in the sealing contact part of the rear-cover, instead of the use of a steel sleeve therein as is done in the conventional art, to achieve a lightweight (60 to 100 g) rear-cover and improve the abrasion-resistance thereof (5 times improvement relative to that using the steel sleeve).

The invention has been described in detail with reference to preferred embodiments thereof. However, it will be appreciated by those skilled in the art that various modifications and changes may be made in these embodiments without departing from the principles and spirit of the invention, the scope of which is defined in the appended claims and their equivalents.

1. A rear-cover of a transmission, the rear-cover made of an aluminum alloy and having a sealing element contact part in contact with a sealing element of a retainer, the sealing element contact part being at least partially coated with an aluminum oxide film which is in direct contact with the sealing element of the retainer.

2. The rear-cover of the transmission of claim 1, wherein the aluminum oxide film has a thickness of 5 μm to 10 μm.

3. The rear-cover of the transmission of claim 1, wherein only the sealing element contact part is at least partially exposed and immersed in an electrolyte comprising Na₂SiO₃-9H₂O, KF-2H₂O and an aqueous KOH solution to form the aluminum oxide film on the sealing element contact part.

4. The rear-cover of the transmission of claim 1, wherein the sealing element contact part comprises a protrusion extending from the rear-cover.

5. The rear-cover of the transmission of claim 4, wherein the rear-cover further comprises a flow channel configured for passage of oil therethrough, and wherein the protrusion is hollow and in connection with the flow channel of the rear-cover.

6. A system for supplying oil pressure to a vehicle transmission comprising:
a rear-cover fabricated of an aluminum alloy, the rear-cover having an upper and lower surface, a flow channel therethrough, and a hollow sealing element contact part extending from the lower surface, the hollow sealing element being in connection with the flow channel;
a retainer having a sealing element, the sealing element being in direct contact with the sealing element contact part of the rear-cover;
wherein the sealing element contact part is at least partially coated with an aluminum oxide film which is in direct contact with the sealing element of the retainer.
